(19) United States
(12) Patent Application Publication
(10) Pub. No.: US 2011/0228939 A1
(43) Pub. Date: Sep. 22, 2011

(54) SYSTEM AND METHODS FOR OCDM-BASED OPTICAL ENCRYPTION USING SUBSETS OF PHASE-LOCKED FREQUENCY LINES

(75) Inventors: Janet Jackel, Holmdel, NJ (US); Shahab Etemad, Warren, NJ (US); Ronald Menendez, Chatham, NJ (US); Stefano Galli, New York, NY (US); Hossein Izadpanah, Thousand Oaks, CA (US)

(73) Assignee: TELCORDIA TECHNOLOGIES, INC., Piscataway, NJ (US)

(21) Appl. No.: 12/724,631

(22) Filed: Mar. 16, 2010

(51) Int. Cl. H04K 1/04

(52) U.S. Cl. 380/256

(57) ABSTRACT

A method for optical signal processing includes receiving an optical signal containing a plurality of frequency lines, defining at least two wavesets including an updatable random subset of the frequency lines, receiving a data stream, modulating the optical signal with the data stream, encrypting the data stream by extracting the subset of the frequency lines of the at least two wavesets from the modulated optical signal, and phase coding the subset of frequency lines of the at least two wavesets in the modulated optical signal.

### BACKGROUND

1. Technical Field

This invention generally relates to optical signal processing. In particular, this invention relates to systems and methods of optical encryption based on optical code division multiplexing (OCDM).

2. Description of the Related Art

Modern day digital communications are dominated by optics (such as fiber-optic networks), because of the ability of fiber-optic networks to transmit information over particularly long distances at high rates with relatively little loss. At an origin, digital data in electronic form modulate an optical signal, such that the optical signal carries the digital data. The modulated optical signal is transmitted through an optical fiber to a destination. At the destination, the optical signal is demodulated to extract the electronic digital data. Thus, fiber-optic communication systems include electronic components for processing electronic digital data and optical components for processing optical signals modulated by the electronic data.

As all communications that traverse a public space such as the wireless cellular networks, high rate data communications over public fiber optics networks are susceptible to eavesdropping and require certain security measures. For example, the Office of the Comptroller of Currency in the U.S. will require the financial sectors to encrypt optical communications leaving their secure locations in the near future.

However, at increasingly high data rates such as 40 Gb/s or 100 Gb/s, protection against eavesdropping and/or snooping through data encryption at the electronic level becomes difficult with today's technology. Indeed, today's encryption technology, such as the Advanced Encryption Standard (AES), adds additional overhead, requires additional bandwidth, and imposes high end-to-end cost of implementation.

In contrast, the tremendous capacity of public dark fibers and the capabilities of emerging optical components create a compelling case for providing security protection at the optical layer (i.e., photonic layer security).

FIG. 1 illustrates a photonic layer security solution. Referring to FIG. 1, an optical signal 102 carrying data at a high rate, e.g., 100 Gb/s, is scrambled by a phase scrambler 104. Optical signal 102 contains multiple frequency components, and phase scrambler 104 scrambles optical signal 102 by introducing phase shifts to the respective frequency components. The scrambled optical signal travels through optical fiber(s) 106 to a receiver. The particular assignment of phase shifts for the multiple frequency components used by phase scrambler 104 at the transmitter end is a key for retrieving data at the receiver end. An authorized recipient would be able correctly retrieve the data in the received optical signal as shown in box 108 using a descrambler 110 configured with the right key. An unauthorized recipient attempting to snoop the data in the scrambled optical signal, however, will only be able to see the received optical signal as noise shown in box 112.

OCDM technology is generally used to provide very high rate data transmissions. Still with reference to FIG. 1, to construct the optical signal 102 carrying high rate data, the data stream may be first inverse multiplexed into a number of lower rate tributaries. For example, a 100 Gb/s data stream may be split up into four 25 Gb/s sub-streams or ten 10 Gb/s sub-streams. The lower rate sub-streams or tributaries may then separately modulate the output of a mode-locked laser (MLL) that acts as a carrier optical signal. As is well known in the art, the laser output contains multiple frequency components or frequency lines. As each lower rate sub-stream modulates a copy of the optical signal output from the laser, a unique OCDM code is applied to the sub-stream in the form of phase shifts to the frequency components. The OCDM codes for the sub-streams are defined to be orthogonal to one another. With this orthogonality, the sub-streams coded with their respective OCDM codes can be combined before transmission without losing the individual identities, and can then be separated from one another at the receiver end. Thus, the use of the orthogonal OCDM codes allows for combining a number of lower rate data sub-streams into a very high rate data stream.

Some other exemplar photonic layer security solutions are described in U.S. Pat. No. 7,574,144 and U.S. Patent Application Publication No. 2008/0107430 A1, the entire contents of which are incorporated herein by reference.

This invention provides an improved photonic layer security solution for systems based on optical code division multiplexing (OCDM).

### SUMMARY

In accordance with the invention, there is provided a method of optical signal processing, including receiving an optical signal including a plurality of frequency lines; defining at least two wavesets including an updatable random subset of the frequency lines; receiving a data stream; modulating the optical signal with the data stream; encrypting the data stream by extracting the subset of the frequency lines of the at least two wavesets from the modulated optical signal; and phase coding the subset of frequency lines of the at least two wavesets in the modulated optical signal.

In accordance with the invention, there is further provided a transmitter for optical signal processing, including: at least one modulator configured to receive a data stream and an optical signal, the optical signal including a plurality of frequency lines, the at least one modulator further configured to modulate the optical signal with the data stream; and at least one phase coder configured to define at least two wavesets including an updatable random subset of the frequency lines, encrypt the data stream by extracting the random of the frequency lines of the at least two wavesets from the modulated optical signal, and phase code the subset of frequency lines of the at least two wavesets in the modulated optical signal.

In accordance with the invention, there is further provided a receiver for optical signal processing, including: at least one phase decoder configured to receive a phase coded modulated optical signal, identify at least two wavesets including an updatable random subset of frequency lines, and perform phase decoding on the random set of frequency lines of the at least two wavesets in the phase coded modulated optical signal; and at least one demodulator configured to receive the modulated optical signal after the phase decoder performs the phase decoding and demodulate the modulated optical signal to extract at least one data stream.

It is important to understand that both the foregoing general description and the following detailed description are exemplary and explanatory only, and are not restrictive of the invention as claimed.

### BRIEF DESCRIPTION OF THE DRAWINGS

The accompanying drawings, which are incorporated in and constitute a part of this specification, illustrate various embodiments. In the drawings:

FIG. 1 illustrates a photonic layer security solution;

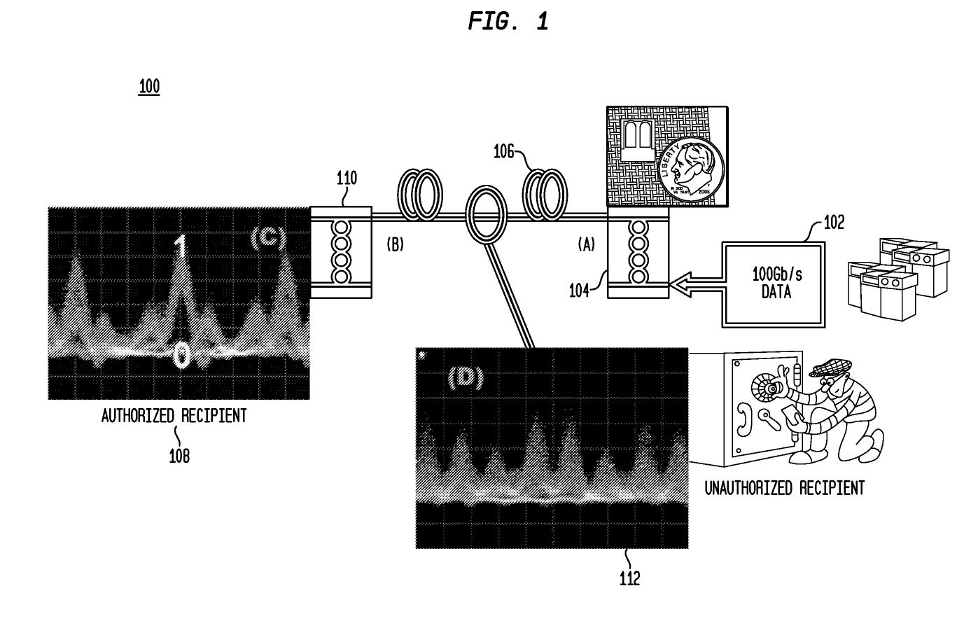

FIG. 2 exemplarily depicts the frequency properties of an optical signal output from a mode-locked laser;

FIG. 3 illustrates an exemplary transmitter that uses wavesets to process and transmit data; and

FIG. 4 illustrates a system architecture consistent with disclosed embodiments.

### DESCRIPTION OF THE EMBODIMENTS

In the following description, for purposes of explanation and not limitation, specific techniques and embodiments are set forth, such as particular sequences of steps, interfaces, and configurations, in order to provide a thorough understanding of the techniques presented here. While the techniques and embodiments will primarily be described in the context of the accompanying drawings, those skilled in the art will further appreciate that the techniques and embodiments can also be practiced in other electronic devices or systems.

Reference will now be made in detail to exemplary embodiments of the present invention, examples of which are illustrated in the accompanying drawings. Whenever possible, the same reference numbers will be used throughout the drawings to refer to the same or like parts.

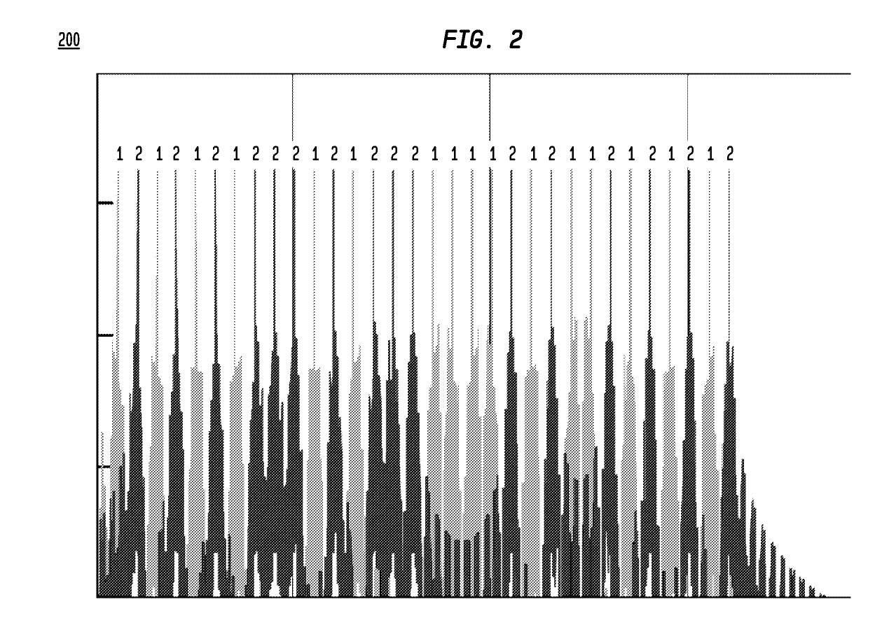

Consistent with embodiments of the present invention, there are provided security solutions implemented not only in the phase dimension, but also in the frequency dimension. More specifically, a laser generates optical pulses containing a great number of frequency components, or frequency lines, or wavelengths. When data modulate only some of the frequency lines at a transmitter, a receiver needs to know exactly which frequency lines were used by the transmitter in order to retrieve the data. The present invention introduces an additional layer of security based on random selections of frequency lines used for transmitting data streams or sub-streams, as illustrated in FIG. 2.

FIG. 2 exemplarily depicts the frequency properties of the optical signal output from a mode-locked laser. As shown in graph 200 of FIG. 2, a laser output may contain a number of frequency lines or wavelengths. The x-axis of graph 200 measures frequency and the y-axis measures the amplitude of the frequency lines.

Consistent with embodiments of the present invention, the available frequency lines in the laser output may be grouped into distinct subsets, where the exact grouping is held as a security key known only to the entities privy to the relevant communication. For example, as shown in FIG. 2, the entire set of frequency lines of the laser output may be separated into two distinct groups called wavesets, such that the frequency lines in the two wavesets are randomly distributed. Moreover, the two wavesets are distinct and do not have any frequency lines in common. In FIG. 2, the frequency lines labeled with “1” belong to waveset 1, and the frequency lines labeled with “2” belong to waveset 2. The randomness of the frequency lines creates an additional barrier against an eavesdropper. When a waveset is used to carry some data, an eavesdropper would not be able to snoop the data unless s/he first identifies the frequency lines in that waveset.

Although FIG. 2 shows that the frequency lines in the laser output are grouped into two wavesets, more wavesets can be defined each containing several frequency lines. Additionally, it is to be understood that the randomness does not exclude any particular selection of frequency lines for a waveset. For example, a waveset consisting of the first four adjacent frequency lines may not appear to be random, but as long as the knowledge of the composition of the waveset is limited to the relevant parties, an eavesdropper would still need to guess what the frequency lines are before s/he can retrieve any data transmitted using that waveset.

Thus, the randomly defined wavesets may contain intermingled frequency lines, as shown in FIG. 2. For example, in FIG. 2 the first frequency line belongs to waveset 1, the second frequency line belongs to waveset 2, and the third frequency line belongs to waveset 1. Moreover, groups of frequency lines may be separated by a gap and non-intermingled groups of frequency lines may exist without gaps in-between. In addition, the number of frequency lines may differ between wavesets.

Once the wavesets are defined, the wavesets may each carry data to be transmitted.

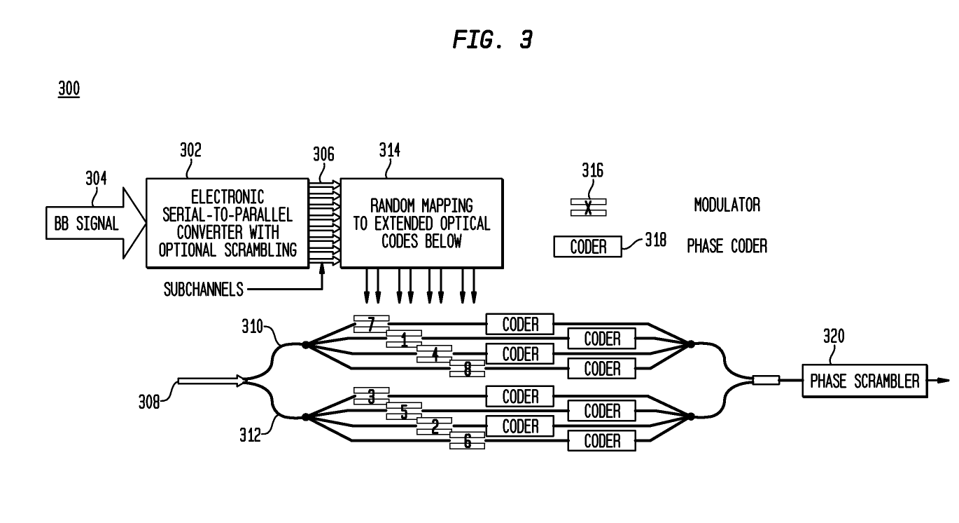

FIG. 3 illustrates an exemplary transmitter 300 that uses wavesets to process and transmit data.

Transmitter 300 includes serial-to-parallel converter 302. Converter 302 receives a broadband (BB) signal 304. Converter 302 converts the BB signal 304 into a plurality of parallel data sub-streams using inverse multiplexing. The data sub-streams may correspond to a plurality of sub-channels 306.

Transmitter 300 also includes a source of phase locked laser lines, such as a mode locked laser (MLL), not shown, that generates optical pulses or an optical pulse train 308. Optical pulse train 308 will be shared by all wavesets.

As shown in FIG. 3, the optical pulses from the MLL are provided to two branches 310 and 312 each to separately process certain data to be transmitted. In some embodiments, each of the optical pulses in branches 310 and 312 may be copies of the optical pulses from the MLL, and include the same frequency lines. In the exemplary transmitter 300 of FIG. 3, branch 310 processes data using a first waveset and branch 312 processes data using a second waveset. The first and second wavesets may be defined as discussed above consistent with embodiments of the present invention.

Consistent with embodiments of the present invention, the randomly defined wavesets can further be used with OCDM such that each waveset can carry multiple data streams or sub-streams each phase coded with a code from an orthogonal phase code set. The phase codes, however, need not be orthogonal between wavesets. Because the sub-streams may be individually phase coded with different codes, the sub-streams obscure each other.

In the exemplary transmitter 300 of FIG. 3, each of branches 310 and 312 includes pairs of modulator 316 and phase coder 318, each pair within a branch corresponding to one of the orthogonal phase codes to be used for the waveset. In the example shown in FIG. 3, each branch consists of four such pairs and therefore, handles four data sub-channels or sub-streams. Also, the four pairs in each branch operate on the same waveset. Moreover, the four phase coders 318 in the four pairs of a branch are assigned different but orthogonal phase codes.

It is to be understood that the depiction of two separate branches 310 and 312 is only for illustration purposes. One skilled in the art should understand that no physical separation between the two branches is needed.

Consistent with embodiments of the present invention, when a broadband signal is inversely multiplexed to create multiple sub-streams or sub-channels, the sub-streams may be carried over the same waveset or different wavesets. Similarly, a waveset may carry the sub-streams from multiple broadband signals. The assignment of the sub-streams to the wavesets adds another layer of security, as the receiver must know which wavesets are used to carry which sub-stream of the broadband signal the receiver is trying to detect.

In the exemplary transmitter 300, a mapper 314 assigns the data sub-streams on sub-channels 306 to the wavesets and the phase codes within the wavesets. Mapper 314 may be part of converter 302 or a separate device. In the example shown in FIG. 3, mapper 314 maps data sub-channels 7, 1, 4, 8 to four phase codes in the first waveset of branch 310, and maps data sub-channels 3, 5, 2, 6 to four phase codes in the second waveset of branch 312.

One of ordinary skill in the art should understand that, assuming a binary phase shift, i.e., either 0 or π, a waveset with four frequency lines allows for four orthogonal phase codes, and a waveset with eight frequency lines allows for eight orthogonal phase codes. However, consistent with embodiments of the present invention, not all available phase codes need to be used. Thus, even though FIG. 3 suggests four phase codes for each waveset, it is to be understood that each waveset may include more than four frequency lines, e.g., 8 or 16 frequency lines, which theoretically allow for more than four phase codes.

With non-binary phase shifts, a larger code-space can be available. For example, if phase coders 318 can implement phase shifts of 0, π/2, 3π/4, and π, the number of orthogonal phase codes is much greater than that with binary phase shifts. One of ordinary skill in the art will also appreciate that different code sets may be used, such as Barker codes, Hadamard-Walsh codes.

Additionally, different phase coding schemes can be adopted for different wavesets. For example, binary Hadamard-Walsh codes may be used with one waveset, while non-binary phase shifts are used with another waveset.

In addition, although FIG. 3 shows that the 8 sub-streams of broadband signal 304 are assigned to the first and second wavesets such that each waveset carries four sub-streams, each waveset may carry not only the sub-streams of broadband signal 304, but can carry additional data from other sources. For example, the first waveset of branch 310 may carry three, instead of four, sub-streams of broadband signal 304, and another data stream or sub-stream from a different source. Alternatively, for example, a random data stream may be transmitted using the fourth phase code, thereby obscuring the real data and making eavesdropping even more difficult. The random data stream may be received from a noise generator.

The data sub-stream assigned to a particular phase code of a particular waveset first modulates the optical signal output of the MLL at data modulator 316. The modulated optical signal is then subject to phase coding at phase coder 318. Phase coder 318 performs phase coding by introducing phase shifts to the frequency components of the modulated optical signal based on the corresponding phase code, where the frequency components are of the corresponding waveset. Moreover, phase coder 318 may define and/or identify the frequency components of its corresponding waveset.

Data modulator 316 modulates the optical signals using any suitable modulation scheme, such as on-off keying (OOK), duobinary, differential phase shift keying (DPSK), or multi-amplitude/phase constellations such as QAM, PSK, etc. One of ordinary skill in the art should understand how these or any other known modulation scheme works, and therefore detailed explanations thereof are not provided herein.

Phase coder 318 may be implemented using ring resonator filters, as reviewed in the IEEE Communications Magazine article “An Overlay Photonic Layer Security System Scaleable to 100 Gb/s” Etemad et al. August 2008, the entire contents of which are hereby incorporated by reference. The notion that the OCDM signals can occupy non-contiguous frequency lines was introduced in the incorporated U.S. Pat. No. 7,574,144 to Galli et al. It is to be understood, however, that any structure capable of phase coding can be used as phase coder 318. Moreover, as mentioned above, different phase coding techniques, e.g., binary or non-binary, may be used by phase coder 318, such as binary phase coding.

After each sub-channel goes through data modulation and phase coding, the sub-channels are combined. In other words, the optical signals modulated by the data sub-streams and phase coded are combined and then sent to a phase scrambler 320. Phase scrambler 320 performs phase scrambling on the combined optical signal. In particular, phase scrambler 320 introduces further phase shifts to the frequency lines in the combined optical signal according to a scrambling key. The functionality of phase scrambler 320 may be combined with phase coders 318. Phase scrambler 320 outputs an optically encrypted signal that is ready for transmission. Moreover, the identification of the frequency lines within the at least two wavesets encoded by phase coder 318 may be sent to a receiving end, so that the receiving end can decode the optically encrypted signal.

As the wavesets include only subsets of the frequency lines of the laser output, frequency lines not belonging to a waveset need to be removed. In one aspect, phase coder 318 removes the frequency lines except those belonging to the waveset the phase coder operates on. In another aspect, a separate component may be included in transmitter 300 to remove the irrelevant frequency lines either before data modulation at data modulator 316, between data modulation and phase coding at phase coder 318, or after phase coding. By extracting the frequency lines of the wavesets, a data stream modulating the optical signal including the frequency lines is encrypted in the sense that the exact frequency lines of the wavesets becomes a key to receiving and decoding the data.

Moreover, the frequency lines assigned to the wavesets may be changed from time to time, either regularly or randomly. The updating of the frequency lines may be effected through an update of the phase coder 318 to phase code the frequency lines in the new wavesets, and the removal of the corresponding remaining frequency lines.

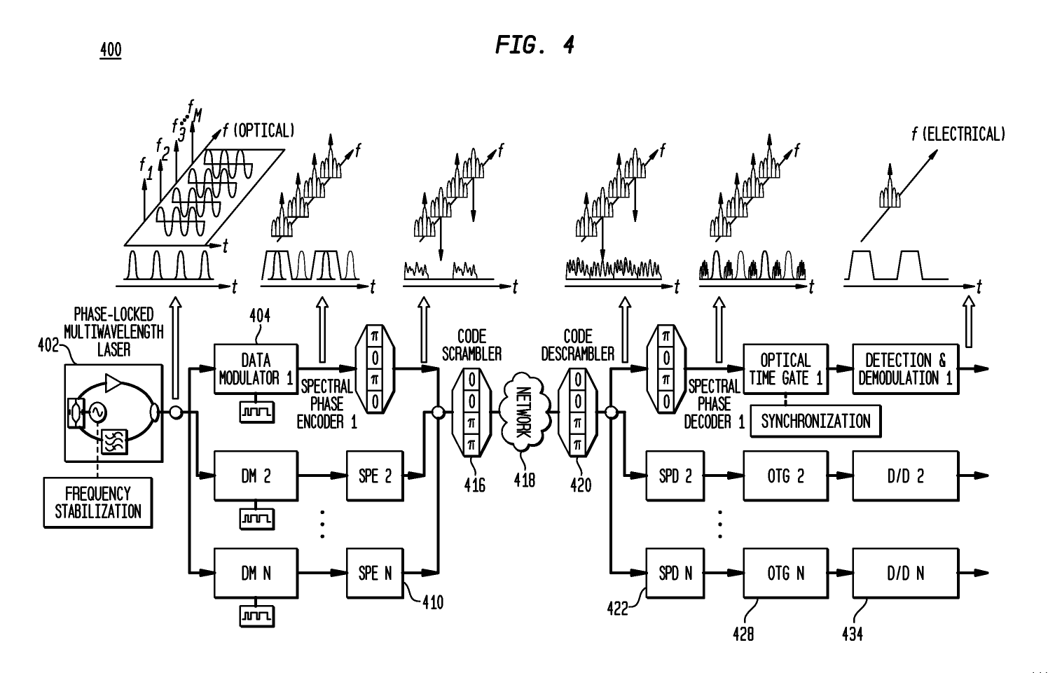

FIG. 4 illustrates a system 400 consistent with the present invention. In addition to a transmitter, system 400 also illustrates reversing the phase encoding and phase scrambling at a receiving end. FIG. 4 also depicts signal flows through the system 400 in the time and frequency domains.

System 400 includes a laser source 402, such as a phase-locked multi wavelength laser, which generates an optical pulse train that is simultaneously fed into data modulators 404, including DM 1, DM 2, . . . DM N. Data modulators 404 each receive a sub-stream of data that is used to modulate the optical pulse train. Each of the data modulators 404 outputs a modulated optical sub-stream.

Each modulated optical sub-stream is then fed to a corresponding spectral phase encoder (SPE) 410 for phase coding on an assigned waveset as described above in FIG. 3. For example, DM 1 feeds its modulated optical sub-stream to SPE 1, DM 2 feeds its modulated optical sub-stream to SPE 2, and DM N feeds its modulated optical sub-stream to SPE N.

SPE 1, SPE 2, . . . SPE N output their respective modulated and coded optical sub-streams, which are then passively combined with each other using bit-time synchronization. The passively combined stream then passes through a shared phase code scrambler 416. In some embodiments, shared phase code scrambler 416 may be combined with each of SPE 1, SPE 2, . . . SPE N. Shared phase code scrambler 416 performs phase code scrambling with a random key on the combined signal.

The scrambled optical signal may be transmitted over an optical medium to a network 418, such as a WDM or Dense WDM (DWDM) network to the receiving end. At the receiving end, code descrambler 420 undoes the scrambling using the random key. The unscrambled coded modulated data stream passes through spectral phase decoders (SPD) 422, including SPD 1, SPD 2, . . . SPD N for phase decoding. The SPDs operate on the same wavesets as were used for spectral phase encoding by the transmitter. Code descrambler 420 may be combined with each of SPD 1, SPD 2, . . . SPD N. Each of SPD 1, SPD 2, . . . SPD N outputs a decoded modulated optical stream to one of optical time gates (OTG) 428, including OTG 1, OTG 2, . . . OTG N. Each of OTG 1, OTG 2, . . . OTG N extracts only a desired tributary from among the decoded stream, thereby each outputting a modulated optical sub-stream. The modulated optical sub-streams then each pass through one of Detection and Demodulation (DID) modules 434, including D/D 1, D/D 2, . . . D/D N to reproduce the original data sub-streams that were fed into data modulators 404. In some embodiments, some of the data-streams may include random data that was used by the transmitter to obscure a data stream.

In view of the descriptions of FIG. 3, the operation of the system in FIG. 4 is clear to one of ordinary skill in the art and is not discussed in detail.

The foregoing description has been presented for purposes of illustration. It is not exhaustive and does not limit the invention to the precise forms or embodiments disclosed. Modifications and adaptations of the invention can be made from consideration of the specification and practice of the disclosed embodiments of the invention.

For example, one or more steps of methods described above may be performed in a different order or concurrently and still achieve desirable results.

Moreover, the above descriptions of the embodiments refer to components of a system. It is to be understood that the components may be implemented as hardware or software, or a combination thereof. For example, mapper 314 of FIG. 3 may be a hardware component, or may simply be implemented as a software instruction that maps data sub-streams to different phase codes of the wavesets.

In addition, the description associated with FIG. 2 does not suggest that all frequency lines output from a laser must be allocated to the wavesets. Rather, a system consistent with the present invention may allocate some of the frequency lines to the wavesets, and leave other frequency lines for other purposes, such as conventional WDM (wavelength division multiplexing) or DWDM (dense WCDM) communications.

Other embodiments of the invention will be apparent to those skilled in the art from consideration of the specification and practice of the invention disclosed herein. It is intended that the specification and examples be considered as exemplary only, with a true scope of the invention being indicated by the following claims.

What is claimed is:

1. A method of optical signal processing, comprising the steps of:
receiving an optical signal including a plurality of frequency lines;
defining at least two wavesets including an updatable random subset of the frequency lines;
receiving a data stream;
modulating the optical signal with the data stream;
encrypting the data stream by extracting the subset of the frequency lines of the at least two wavesets from the modulated optical signal; and
phase coding the subset of frequency lines of the at least two wavesets in the modulated optical signal.

2. The method of claim 1, wherein the step of defining further comprises the step of:
randomly defining at least a first waveset and a second waveset that do not have any of the frequency lines in common.

3. The method of claim 2, wherein frequency lines of the first waveset and frequency lines of the second waveset are intermingled.

4. The method of claim 2, further comprising the steps of:
inverse multiplexing the data stream into a plurality of sub-streams;
modulating individual copies of the optical signal with individual ones of the sub-streams; and
phase coding the modulated individual copies of the optical signal.

5. The method of claim 4, wherein the step of phase coding the modulated individual copies of the optical signal further comprises the steps of:
phase coding frequency lines of the first waveset in a copy of the optical signal modulated by a first of the sub-streams with a first phase code; and
phase coding frequency lines of the first waveset in a copy of the optical signal modulated by a second of the sub-streams with a second phase code,
wherein the first phase code is orthogonal to the second phase code.

6. The method of claim 4, wherein the step of phase coding the modulated individual copies of the optical signal further comprises the steps of:
phase coding frequency lines of the first waveset in a copy of the optical signal modulated by a first of the sub-streams with a first phase code; and
phase coding frequency lines of the second waveset in a copy of the optical signal modulated by a second of the sub-streams with a second phase code,
wherein the first phase code is not orthogonal to the second phase code.

7. The method of claim 4, further comprising:
combining the phase coded and modulated individual copies of the optical signal; and
phase scrambling the combined optical signal.

8. The method of claim 1, wherein:
the step of modulating further comprises the step of modulating a copy of the optical signal with a random data stream to obscure the data stream; and
the step of phase coding further comprises the step of phase coding the subset of frequency lines of the at least two wavesets in the copy of the modulated optical signal.

9. The method of claim 1, wherein the step of receiving further comprises the step of:
receiving the optical signal from a mode locked laser.

10. The method of claim 1, wherein the step of modulating is processed according to at least one of: on-off keying (OOK), duobinary, differential phase shift keying (DPSK), or multi-amplitude/phase constellations.

11. The method of claim 1, wherein the data stream is a first data stream and the optical signal is a first optical signal, the method further comprising the steps of:
receiving a second data stream from a different source than the first data stream;
modulating the first optical signal with the first data stream;
modulating a second optical signal with the second data stream; and
phase coding frequency lines of the same waveset in the first modulated optical signal and the second modulated optical signal.

12. The method of claim 1, wherein the step of phase coding applies a binary phase shift.

13. The method of claim 1, further comprising the step of:
sending an identification of the frequency lines of the at least two wavesets to a receiver.

14. A transmitter for optical signal processing, comprising:
at least one modulator configured to receive a data stream and an optical signal, the optical signal including a plurality of frequency lines, the at least one modulator further configured to modulate the optical signal with the data stream; and
at least one phase coder configured to:
define at least two wavesets including an updatable random subset of the frequency lines;
encrypt the data stream by extracting the random subset of the frequency lines of the at least two wavesets from the modulated optical signal; and
phase code the subset of frequency lines of the at least two wavesets in the modulated optical signal.

15. The transmitter of claim 14, wherein the at least one phase coder is further configured to:
randomly define at least a first waveset and a second waveset that do not have any of the frequency lines in common.

16. The transmitter of claim 15, wherein frequency lines of the first waveset and frequency lines of the second waveset are intermingled.

17. The transmitter of claim 15, further comprising a converter configured to inverse multiplex the data stream into a plurality of sub-streams, wherein:
the at least one modulator is further configured to modulate individual copies of the optical signal with individual ones of the sub-streams; and
the at least one phase coder is further configured to phase code the modulated individual copies of the optical signal.

18. The transmitter of claim 17, wherein the at least one phase coder is further configured to:
phase code frequency lines of the first waveset in a copy of the optical signal modulated by a first of the sub-streams with a first phase code; and
phase code frequency lines of the first waveset in a copy of the optical signal modulated by a second of the sub-streams with a second phase code,
wherein the first phase code is orthogonal to the second phase code.

19. The transmitter of claim 17, wherein the at least one phase coder is further configured to:
phase code frequency lines of the first waveset in a copy of the optical signal modulated by a first of the sub-streams with a first phase code; and
phase code frequency lines of the second waveset in a copy of the optical signal modulated by a second of the sub-streams with a second phase code,
wherein the first phase code is not orthogonal to the second phase code.

20. The transmitter of claim 17, further comprising a phase scrambler configured to:
receive a combined optical signal of the phase coded and modulated individual copies of the optical signal; and
phase scramble the combined optical signal.

21. The transmitter of claim 14, wherein:
the at least one modulator is further configured to modulate a copy of the optical signal with a random data stream to obscure the data stream; and
the at least one phase coder is further configured to phase code the subset of frequency lines of the at least two wavesets in the copy of the modulated optical signal.

22. The transmitter of claim 14, further comprising a mode locked laser configured to provide the optical signal.

23. The transmitter of claim 22, wherein the at least one modulator is configured to operate according to at least one of: on-off keying (OOK), duobinary, differential phase shift keying (DPSK), or multi-amplitude/phase constellations.

24. The transmitter of claim 14, wherein the data stream is a first data stream and the optical signal is a first optical signal, wherein the at least one modulator is further configured to:
receive a second data stream from a different source than the first data stream;
modulate the first optical signal with the first data stream; and
modulate a second optical signal with the second data stream,
wherein the at least one phase coder is further configured to phase code frequency lines of the same waveset in the first modulated optical signal and the second modulated optical signal.

25. The transmitter of claim 14, wherein the phase coder is further configured to apply a binary phase shift.

26. The transmitter of claim 14, wherein the transmitter is configured to send an identification of the frequency lines of the at least two wavesets to a receiver.

27. A receiver for optical signal processing, comprising:
at least one phase decoder configured to receive a phase coded modulated optical signal, identify at least two wavesets including a random subset of frequency lines, and perform phase decoding on the random set of frequency lines of the at least two wavesets in the phase coded modulated optical signal; and
at least one demodulator configured to receive the modulated optical signal after the phase decoder performs the phase decoding and demodulate the modulated optical signal to extract at least one data stream.

28. The receiver of claim 27, wherein the at least one phase decoder is further configured to:
identify at least a first waveset and a second waveset that do not have any frequency lines in common.

29. The receiver of claim 28, wherein frequency lines of the first waveset and frequency lines of the second waveset are intermingled.

30. The receiver of claim 27, further comprising a phase descrambler configured to:
receive a scrambled phase coded modulated optical signal;
descramble the scrambled phase coded modulated optical signal into the phase coded modulated optical signal; and
send the phase coded modulated optical signal to the at least one phase decoder.

31. The receiver of claim 27, wherein the at least one demodulator is further configured to demodulate the modulated optical signal to extract a random data stream, the random data stream obscuring the data stream modulating the optical signal.

32. The receiver of claim 27, wherein the receiver is configured to receiver an identification of the frequency lines of the at least two wavesets from a transmitter.
